(19) United States
(12) Patent Application Publication
(10) Pub. No.: US 2004/0144881 A1
(43) Pub. Date: Jul. 29, 2004

(54) Application tool

(76) Inventors: Alan Whyte, Edinburgh (GB); Stewart Robertson, Kilmacolm (GB); John Patterson, Cambuslang (GB)

Correspondence Address: TESTA, HURWITZ & THIBEAULT, LLP, HIGH STREET TOWER, 125 HIGH STREET, BOSTON, MA, 02110, US

(21) Appl. No.: 10/663,429

(22) Filed: Sep. 16, 2003

(30) Foreign Application Priority Data
Sep. 19, 2002 (GB) 0221741.2

(51) Int. Cl. B23P 11/00; B65H 16/04

(52) U.S. Cl. 242/557; 29/428

(57) ABSTRACT

A method and tool for applying a sheet material to a surface of a structure, and in particular a vehicle. The tool comprises a locating assembly for locating the tool with respect to the structure, the locating assembly including a support frame and translation assembly for allowing relative movement between the structure and the tool. An applicator is supported by the support frame, and applies the sheet material to the surface of the vehicle. The sheet material may be an advertising panel.

### CROSS-REFERENCE TO RELATED APPLICATIONS

This application claims priority to and the benefits of United Kingdom Provisional Patent Application GB 0221741.2, filed Sep. 19, 2002, the disclosures of which are herein incorporated by reference in their entirety.

### FIELD OF THE INVENTION

The present invention relates to a tool and method for applying a sheet material to a surface of a structure, in particular to a surface of a vehicle.

### BACKGROUND OF THE INVENTION

In the field of advertising, there exists a need to temporarily apply advertising display panels to permanent or semi-permanent structures. Such structures traditionally include buildings and billboards. More recently, advertising display panels have been applied to the sides of vehicles in order that they may be used as mobile advertising media. Such advertisements provide a highly visible display reaching potential customers across a range of geographical regions.

Large advertising panels can be difficult to handle and mount onto the surface of the structure. The panel must be securely fastened to prevent peeling, billowing and flapping. Furthermore, it is necessary for the panel to be smoothly applied without creases, air pocket and wrinkles so that the displayed image is not distorted. The dynamic nature of the advertising industry requires that the panels can be changed quickly and easily.

It would therefore be desirable to have equipment suited to the task of mounting a panel to a vehicle surface.

### SUMMARY OF THE INVENTION

It is one object of the invention to provide a tool for easing the mounting of panels to surface structures.

It is another object of the invention to provide a method for mounting a panel to a surface of the structure.

Further aims and objects of the invention will become apparent from a reading of the following description.

According to a first aspect of the invention, there is provided a tool for applying a sheet material to a surface of a structure. The tool includes a locating assembly for locating the tool with respect to the structure, said locating assembly including a support frame and translation assembly for allowing relative movement between the structure and the tool. The tool also includes an applicator for applying the sheet material to the surface, said applicator being supported by the support frame.

The applicator may include a spindle and a central core, the roll of sheet material formed around the central core.

In one embodiment, the support frame includes a spar oriented along a first axis, the spar being suspended above the structure by the translation assembly.

Preferably, the spindle is attached to the spar in a perpendicular arrangement. More preferably, the first axis is oriented perpendicularly to the surface, and the spindle is oriented parallel to the surface.

Two applicators may be provided, one at each opposing end of the support frame.

Preferably, the spindle is rotatable with respect to the support structure. More preferably, the spindle is provided with a clutch mechanism such that rotation of the spindle occurs at a predetermined torque.

The translation assembly may include one or more wheels. The spindle may be provided with a pair of buffers, positioned at either side of the roll of sheet material.

The tool may be provided with auxiliary urging assembly for effecting releasable attachment of the panel to the surface.

The structure may be a vehicle or a part of a vehicle. The panel may be an advertising display panel.

According to a second aspect of the invention, there is provided a tool for applying a sheet material to a surface of a vehicle. The tool includes a locating assembly for locating the tool with respect to the vehicle, said locating assembly including a support frame and a translation assembly for allowing relative movement between the vehicle and the tool. The tool also includes an applicator for applying the sheet material to the surface, said applicator being supported by the support frame.

According to a third aspect of the invention, there is provided a method for applying a sheet material to a surface of a structure. The method includes locating a tool with respect to the structure, said tool comprising a support frame, translation assembly, and applicator supported by the support frame; and removably attaching first portion of the sheet material onto the surface of the structure. The method also includes translating the tool with respect to the structure such that the applicator moves in a direction substantially parallel to the surface, thereby juxtaposing successive portions of the sheet material with the surface.

According to a fourth aspect of the invention, there is provided a method for applying a sheet material to a surface of a vehicle. The method includes locating a tool with respect to the vehicle, said tool comprising a support frame, translation assembly, and an applicator supported by the support frame; and removably attaching first portion of the sheet material onto the surface of the vehicle. The method also includes translating the tool with respect to the structure such that the applicator moves in a direction substantially parallel to the surface, thereby juxtaposing successive portions of the sheet material with the surface.

The method may comprise the additional step of forming the sheet material into a roll on a central core prior to the removable attachment of the first portion of sheet material.

### BRIEF DESCRIPTION OF THE DRAWINGS

There will now be described, by way of example only, various embodiments of the invention with reference to the following drawings, of which:

FIG. 1 shows a perspective view of a tool in accordance with an embodiment of the invention;

FIG. 2 shows a side view of the tool of FIG. 1 in use;

FIG. 3 shows a side view of a tool in accordance with an alternative embodiment of the invention;

FIG. 4 shows a perspective view of a tool in accordance with a further embodiment of the invention; and

FIG. 5 shows a perspective view of a tool in accordance with a further embodiment of the invention.

### DETAILED DESCRIPTION OF THE INVENTION

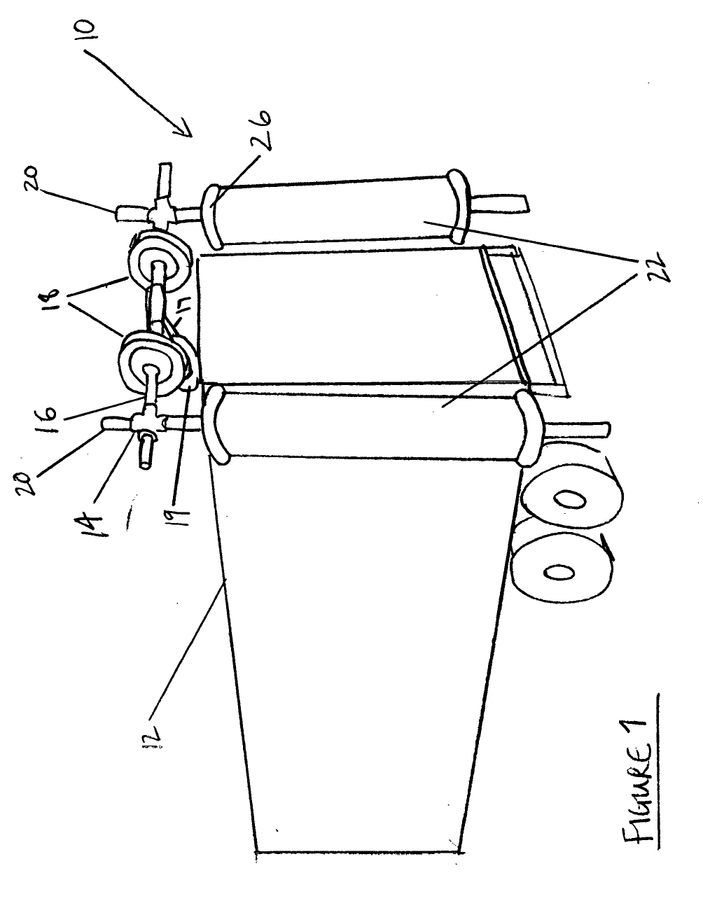

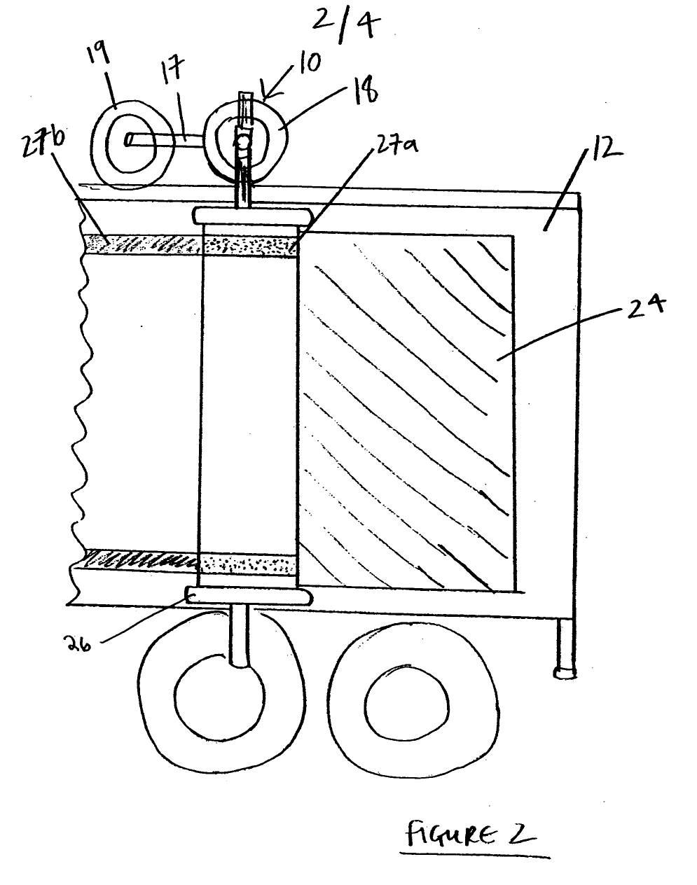

Referring firstly to FIGS. 1 and 2, a tool 10 is shown in position on a vehicle trailer 12. The tool 10 comprises a locating assembly having a support frame 14 and wheels 18, 19. Wheels 18 are mounted on a cylindrical spar 16, located substantially horizontally across the width of the trailer 12. Wheel 19 is mounted on an auxiliary member 17, rigidly fixed to the spar 16 approximately perpendicularly. The wheels 18, 19 rest on the upper surface of the trailer, thereby suspending the support frame above the trailer and across the width of the trailer.

At opposing ends of the spar 16 are mounted vertical spindles 20. Each spindle is connected to a roll 22 of sheet material 24.

Typically the panel has a sheet of PES (polyethersulfone) fabric coated on both sides with PVC, with a matt lacquer applied to the printing side. The lacquer allows the panel to be printed. The sheet is UV stabilised, anti-wicking and fire-retardant. The sheet is substantially non-permeable in that it does not allow liquid or air to readily pass through it.

The size of the sheet may vary to fit the size of the side of a trailer. The typical weight is approximately 460 g/m².

The reverse of the sheet 24 has strips of a fastener 27a attached, for example by bonding with glue, ultrasonic bonding, stapling or stitching. The strips are attached around substantially the entire perimeter of the sheet, in that there are substantially no gaps left for air or fluid ingress after mounting on the truck or truck trailer. Optionally, one or more fasteners may be placed away from the perimeter in order to provide support for the centre of the sheet.

The truck trailer 12 has corresponding fasteners 27b arranged on its side surface, attached for example by bonding with glue, ultrasonic bonding, stapling or stitching.

The roll 22 is formed around a central core (not shown). The spindle is connected to the central core via a locking disc 26, which also functions to cover the end of roll 22. The roll is releasably attachable from the locking disc, and thus is releasably from the tool itself.

The spindle is rotatable with respect to the support frame, such that the entire roll may rotate about a vertical axis. The rotation mechanism of the spindle includes a clutch mechanism that is resistant to rotation of the roll, such that rotation will only be effected when a predetermined torque is applied to the roll. This allows a degree of tension to be maintained in the sheet material during the application process.

In use the tool is located in position on the vehicle as described above. The wheels 18, 19 rest on the upper surface of the vehicle, and suspend the support frame and rolls 22. The Figures show the panel being applied from the rear of the trailer towards the front, although the application may equally be used in the reverse direction, from front to rear.

The outward edge of sheet material is withdrawn from the roll, just enough to align the fasteners at the trailing edge of the panel with the corresponding connectors on the surface of the vehicle. The fasteners are then pushed into engagement. The tool is then moved with respect to the trailer in a forward direction. The clutch mechanism initially resists the unrolling of the sheet material until sufficient tension has built up in the sheet. When the tension is such that a predetermined torque acts to the roll, the sheet material is allowed to unroll and the tool moves along the length of the trailer. As the tool moves, the sheet material is juxtaposed with the surface of the vehicle, and at points immediately rearward of the tool (as it moves towards the front of the trailer), the fasteners 27a, 27b are pushed together to attach the panel.

The tool allows the panel to be attached simply and quickly to the surface of a trailer. The gradual, linear attachment of the panel reduces the likelihood of forming air bubbles, creases, and wrinkles, all of which may distort the displayed image.

The embodiment shown in FIGS. 1 and 2 includes a wheel 19 mounted on an auxiliary member 17. This arrangement allows the whole tool to be pivoted about the spar when loading or unloading rolls 22. By pivoting the tool (in a clockwise direction for the example shown in the Figures), extra ground clearance and manoeuvrability is gained. The wheel arrangement 17, 19 prevents pivoting of the tool in the opposite direction.

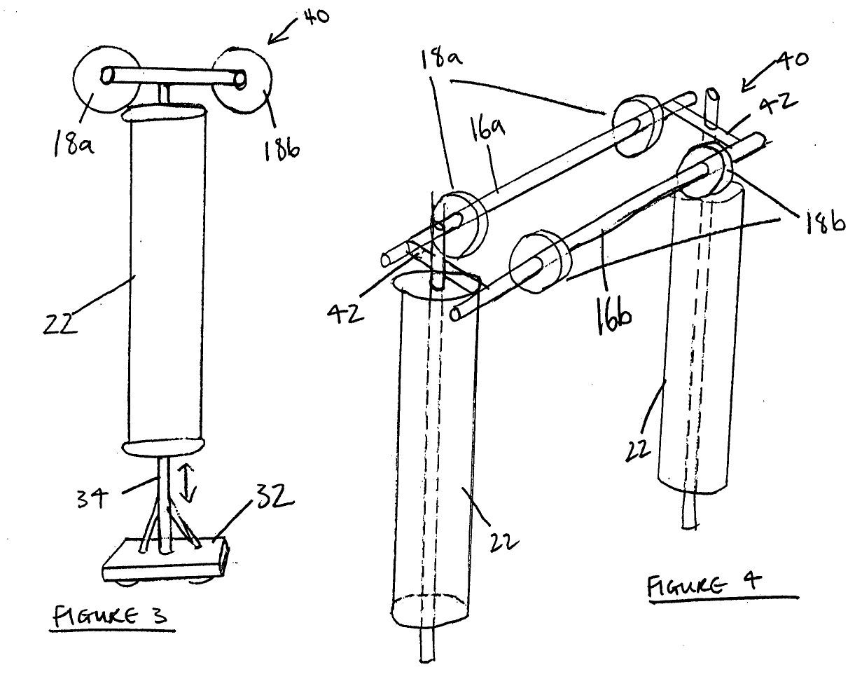

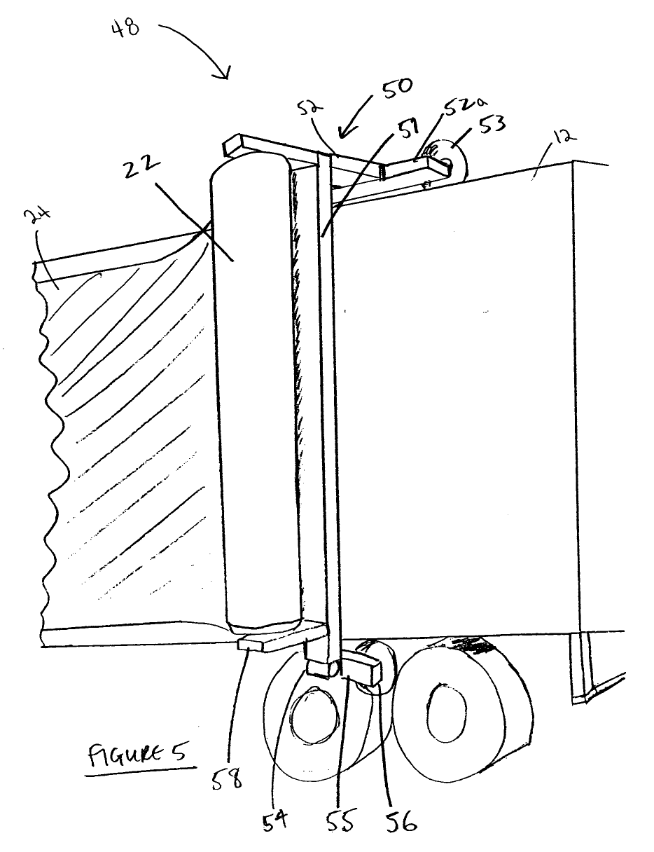

FIGS. 3 and 4 show alternative embodiments of the invention. In these examples, the support frame 40 comprises a pair of horizontal spars 16a, 16b, each having a pair of wheels 18a, 18b mounted thereon. The vertical spindles are mounted centrally on a linking frame member 42. This arrangement makes the tool less prone to pivoting about the spars 16, and thus provides additional stability to the tool.

The embodiment of FIG. 3 is provided with further support by way of the wheeled base assembly 32, which rests on the ground surface during use and storage of the tool. The assembly includes a height adjustable pillar 34, so that the weight of the tool can be distributed between the upper surface of the trailer and the wheeled base assembly.

An alternative embodiment of a tool 48 is shown in FIG. 5. This example includes a support frame arrangement that differs from the above-described embodiments, and has only a single applicator. The support frame 50 includes a locating assembly 52 having an upper frame element 52a running parallel to the vehicle surface. Mounted to the support frame 50 are wheels 53, which rest on the upper surface of the trailer 12 during use.

The tool 48 is also includes a vertical support element 51 running adjacent to the roll 22 of sheet material 24. At the lower end of the vertical support element is a lower frame element 55, having mounted thereto an additional wheel 56. The lower frame element 55 is attached to the vertical support element 51 via a lockable pivot 54. In use, the tool 48 is located by placing the wheel(s) 53 on the upper surface of the trailer 12 while the lower frame element 55 is aligned approximately parallel to the vertical support element 51. Subsequently, the wheel 56 is locked into place on the underside of the vehicle trailer by rotating the lower frame element 55 about the pivot 54. The tool 48 is thus “clamped” onto the trailer 12.

The roll 22 is supported on its underside by bracket 58. To assist in loading and unloading of a roll 22, the bracket 58 is pivotally mounted to the vertical support element 51. The roll 22 is locked to an upper spindle as before, by means of a locking disc (not shown). Thereafter, the bracket 58 is lifted such that it abuts the lower end of the roll 22. A similar locking disc may be utilised.

It will be evident that various modifications may be made to the above-described embodiments within the scope of the invention. For example, the twin-roll arrangement of FIGS. 1 to 4 may utilise a vertical support element and lower bracket as described with reference to FIG. 5.

In addition, one or more rollers may be provided on the tool for urging the fastening materials together. Such rollers may extend rearward (with respect to the direction of movement of the tool) in alignment with the fastening material 27a, 27b. By biasing the rollers against the sheet material, the fasteners may be forced into engagement, removing the need to manually attach the panel.

It is envisaged that the tool may be used to remove a panel from a vehicle and coil the panel into a roll.

Although the foregoing description relates primarily to the application of panels to surfaces on vehicles, the tool may equally be used to apply panels to surfaces of other structures, such as buildings or billboards.

Further modifications and improvements may be added without departing from the scope of the invention herein described.

What is claimed:

1. A tool for applying a sheet material to a surface of a vehicle, comprising:
a locating assembly for locating the tool with respect to the vehicle, said locating assembly including a support frame and translation assembly for allowing relative movement between the vehicle and the tool; and
an applicator for applying the sheet material to the surface, said applicator being supported by the support frame.

2. The tool as claimed in claim 1 wherein the applicator comprises a spindle and a central core, the roll of sheet material formed around the central core.

3. The tool as claimed in claim 2, wherein the support frame comprises a spar oriented along a first axis, the spar being suspended above the structure by the translation assembly.

4. The tool as claimed in claim 3, wherein the spindle is attached to the spar in a perpendicular arrangement.

5. The tool as claimed in claim 3, wherein the first axis is oriented perpendicularly to the surface, and the spindle is oriented parallel to the surface.

6. The tool as claimed in claim 1, wherein two applicators are provided, one at each opposing end of the support frame.

7. The tool as claimed in claim 2, wherein the spindle is rotatable with respect to the support frame.

8. The tool as claimed in claim 7, wherein the spindle is provided with a clutch mechanism such that rotation of the spindle occurs at a predetermined torque.

9. The tool as claimed in any of claims 2, wherein the spindle is provided with a pair of buffers, positioned at either side of the roll of sheet material.

10. The tool as claimed in claim 1, wherein the translation assembly comprises one or more wheels.

11. The tool as claimed in claim 1, further comprising an auxiliary urging assembly adapted to effect releasable attachment of the sheet material to the surface.

12. The tool as claimed in claim 1, wherein the sheet material is an advertising display panel.

13. A tool for applying a sheet material to a surface of a structure, the tool comprising:
a locating assembly for locating the tool with respect to the structure, said locating assembly including a support frame and a translation assembly for allowing relative movement between the structure and the tool; and
an applicator for applying the sheet material to the surface, said applicator being supported by the support frame.

14. A method for applying a sheet material to a surface of a vehicle, comprising the steps of:
locating a tool with respect to the vehicle, said tool comprising a support frame, a translation assembly, and an applicator supported by the support frame;
removably attaching first portion of the sheet material onto the surface of the vehicle; and
translating the tool with respect to the structure such that the applicator moves in a direction substantially parallel to the surface, thereby juxtaposing successive portions of the sheet material with the surface.

15. The method as claimed in claim 14, comprising the additional step of forming the sheet material into a roll on a central core prior to the removable attachment of the first portion of sheet material.

16. A method for applying a sheet material to a surface of a structure, comprising the steps of:
locating a tool with respect to the structure, said tool comprising a support frame, a translation assembly, and an applicator supported by the support frame;
removably attaching first portion of the sheet material onto the surface of the structure; and
translating the tool with respect to the structure such that the applicator moves in a direction substantially parallel to the surface, thereby juxtaposing successive portions of the sheet material with the surface.
